(19) United States
(12) Patent Application Publication
(10) Pub. No.: US 2019/0266675 A1
(43) Pub. Date: Aug. 29, 2019

(54) Methods, system, application for medical mileage transportation tracking and reimbursement

(71) Applicants: Jewel Lynn Palen, Lansing, MI (US); Charles Day Palen, Lansing, MI (US)

(72) Inventors: Jewel Lynn Palen, Lansing, MI (US); Charles Day Palen, Lansing, MI (US)

(73) Assignee: Discover Claims, LLC, Lansing, MI (US)

(21) Appl. No.: 16/208,558

(22) Filed: Dec. 4, 2018

Related U.S. Application Data
(60) Provisional application No. 62/596,466, filed on Dec. 8, 2017.

(51) Int. Cl. G06Q 40/08; G06Q 40/00; H04L 29/08

(52) U.S. Cl. CPC G06Q 40/08; H04L 67/36; G06Q 40/12

(57) ABSTRACT

A computer-implemented system and method are presented to allow the entry, storage, tracking, adjudication, and processing of medical mileage reimbursements through a self-service interactive platform. The invention allows individuals, transportation companies, reimbursing entities, and other users to create, edit and monitor one or more medical mileage reimbursements through the claims process. User medical mileage and related transportation data is entered into a personal computing device and server environment through either direct input, upload, transfer, or abstraction from an external system or device. The invention processes and transforms information via a plurality of synchronous and asynchronous digital and physical interactions to produce actionable data entries for processing and transformation into physical or digital output. User data is transformed and/or presented in digital fields or on physical media to request reimbursement payment and/or adjudicate medical mileage and related transportation reimbursement requests.

### SUMMARY

A methodology to facilitate all users of the designed system to recall, store, organize and present functional data, transmit, create, track, modify, compute the value of a claim for medical mileage and related transportation reimbursement payment, process claim data for reimbursement payment, and to adjudicate medical mileage and related transportation data for the purpose of payment in any form including reimbursement through the use of all devices capable of executing the necessary functions to process information and transmit data through digital networks or standard networks.

The methodology and accompanying system or application allows Users to transform inputted data into standard formatted data fields for presenting medical mileage and related transportation data in a defined form for current, past, and future use to request reimbursement payment.

Medical mileage and related transportation data is transformed into an electronic form that will be capable of being stored on all devices and machines that are capable of executing the necessary functions to process medical mileage reimbursement claims for insurance claim handling, file management, and compliance.

The system, methodology, and/or application allows Users to access an interactive application solution to interact with Users to collect data needed to create and execute a claim for medical mileage and related transportation reimbursement payment, in addition to managing all related current and historic data.

The methodology presented will facilitate data collection, recall, tracking, and analysis for medical mileage and related transportation reimbursement payment, which shall include queries, multiple parties interacting with each other through a designed application that allows data transmission through networks.

### BRIEF DESCRIPTION OF THE DRAWINGS

FIG. 1 is a high-level block diagram representing one of several configurations of the invention for facilitating reimbursable medical mileage and related transportation expenses.

FIG. 2 is a flow chart demonstrating possible workflow options for a user utilizing the system in accordance with an embodiment of the present invention.

FIG. 3 is a flow chart demonstrating possible workflow options for a transportation user utilizing the system in accordance with an embodiment of the present invention.

FIG. 4 is a flow chart demonstrating possible workflow options for a reimbursing company using the system in accordance with an embodiment of the present invention.

FIG. 5 is a flow chart demonstrating possible workflow occurring within a segment of the system known as “Record Processing Service” intended for processing asynchronous or other communications in accordance with an embodiment of the present invention.

### DETAILED DESCRIPTION

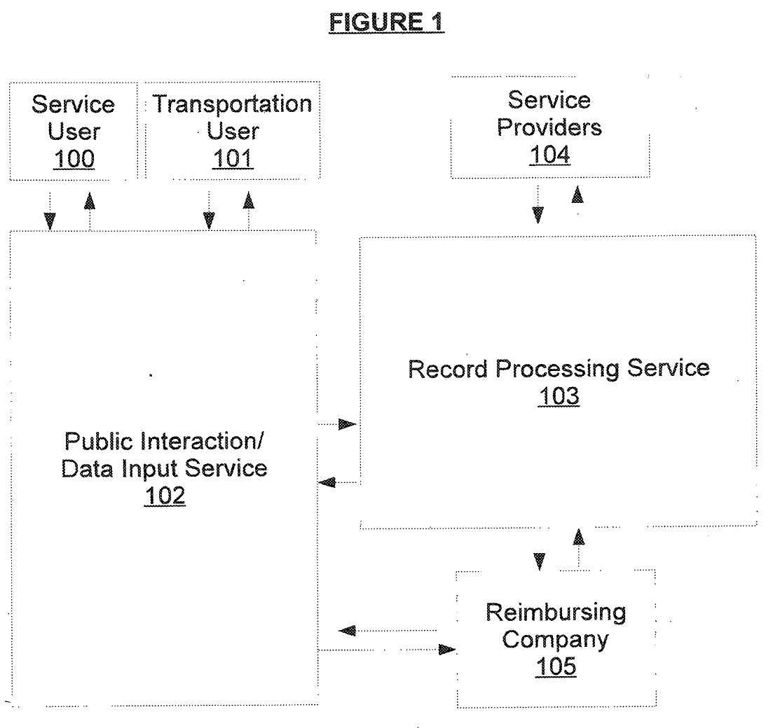

FIG. 1 outlines a network accessible system that may be online or offline for facilitating reimbursable medical mileage expenses between users 100, 101 and a reimbursing company 105. This system is capable of simultaneously or separately servicing one or more users. In the embodiment seen in FIG. 1, Service Users 100 and Transportation Users 101 represent individuals or organizations seeking one or more reimbursements from a reimbursing company 105. In this embodiment, Service Users 100 are thought of as individuals seeking reimbursement. Transportation Users 101 are considered individuals or organizations providing transportation to service users 100 and seeking reimbursement on their behalf.

The system in FIG. 1 is broken into two major sections, Public Interaction and/or Data Input Service 102 and Record Processing Service 103. In the representation, the intent was to organize all synchronous (real-time) interactions with users into the Public Interaction/Data Input Service 102 and all asynchronous (non-real-time) interactions with users into the Record Processing Service 103. Those with ordinary skill in the industry may recognize that this organization can differ between implementations while still achieving the embodiment of the invention.

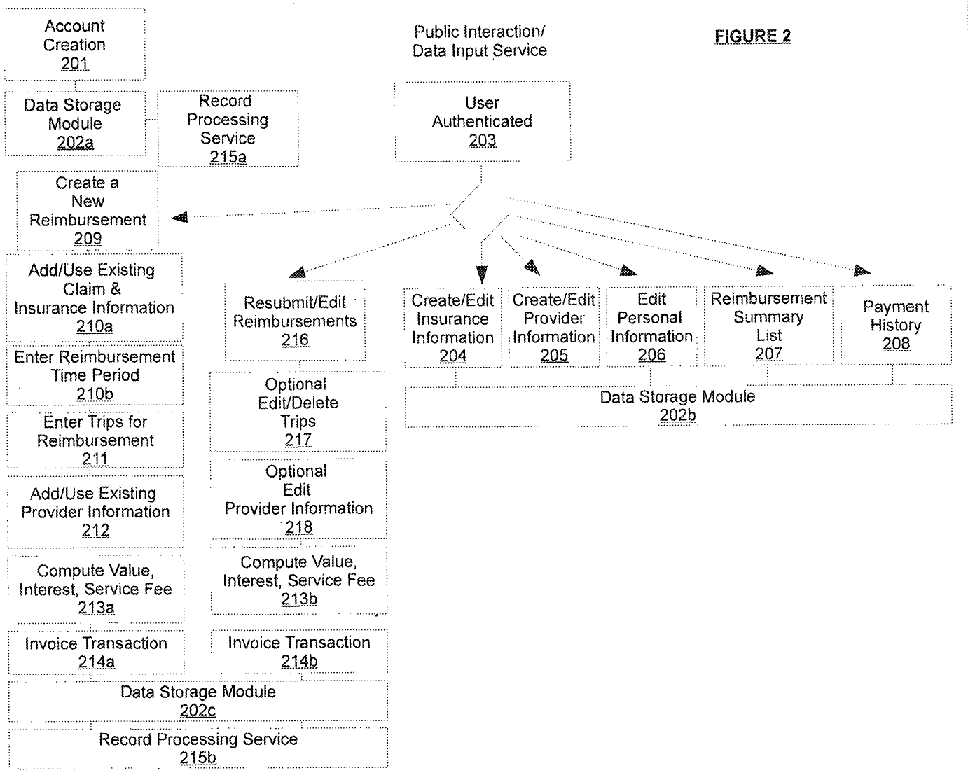

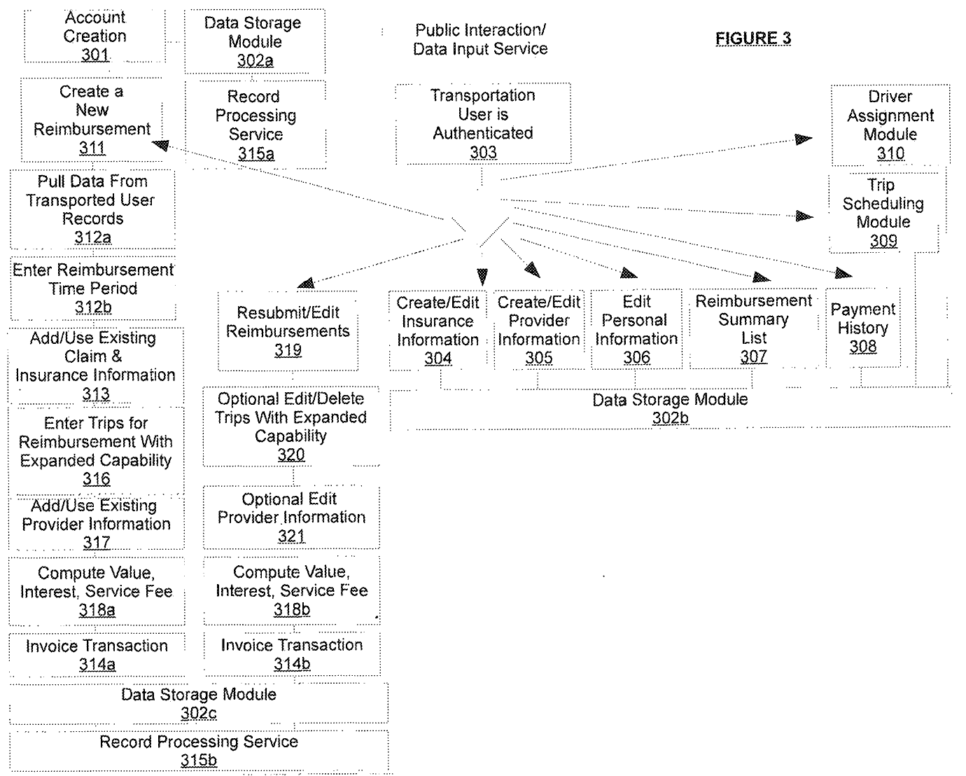

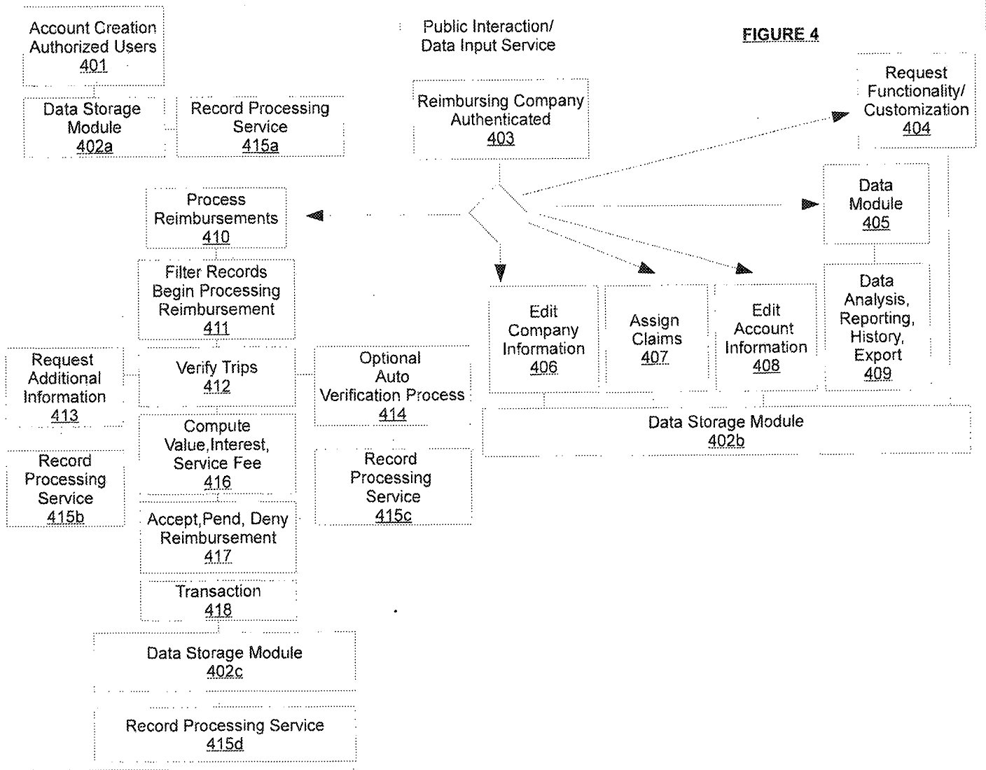

Public Interaction/Data Input Service 102 represents an Internet accessible service where Service Users 100, Transportation Users 101, Reimbursing Company's 105, and Service Providers 104 interact with one another to facilitate reimbursements through data shared between modules in the system. FIG. 2, FIG. 3, and FIG. 4 describe detailed workflows for Service Users 100, Transportation Users 101, and Reimbursing Company's 105 when interacting with services 102 and 103.

FIG. 2 shows one of many possible workflow options for a Service User 100. In FIG. 2, section 201 will present a user interface for facilitating account creation on any device capable of displaying the interface, which if successful will initiate data to be stored in the data storage module 202a. During account creation, the record processing service 215(a) (also seen in 103) may initiate a communication to validate the account that was created. After the user has a valid account, they will be able to securely authenticate as seen in section 203. After the user has been authenticated 203, they will be able to Create a New Reimbursement 209, Resubmit/Edit Reimbursements 216, Create/Edit Insurance Information 204, Create/Edit Provider Information 205, Edit Personal Information 206, interact with a Reimbursement Summary List 207, or access Payment History 208, and have access to increased options as functions are added to the application/system.

When a user Creates a New Reimbursement 209, they will first be able to Add/Use Existing Claim & Insurance Information 210(a). The user may enter completely new information or existing data may be presented from the Data Storage Module 202(c) if the new reimbursement matches previously entered data, such as a common claim identifier or claim number. After claim and insurance information has been entered in a validated format 210(a), users will select the time period that their reimbursement occurred 210(b). Users will then enter trips for reimbursement [211] that occurred within the time period specified. For each trip, users will Add/Use/Modify Existing Provider Information 212 to identify the reimbursable destination for each trip. Users will have the option to select Existing Provider Information 212 loaded from Data Storage Module 202(c) so they do not have to re-enter provider information each time they create a trip. As trips are entered into the system, it will Compute Value, Interest, and Service Fees 213(a) associated with the reimbursement. The computations in 213(a) may use a plurality of data sources and methods for computing the value, interest, and service fees associated with the reimbursement.

Once a reimbursement has accumulated data, users may choose to save the reimbursement request for later submission via the Data Storage Module 202(c) or the User may submit the data for reimbursement payment to the reimbursing company. If users choose to submit the reimbursement request, then an Invoice Transaction 214(a) will occur, which shall not exclude subscription options. The reimbursement may have data stored in the Data Storage Module 202(c), then it may be submitted to the Record Processing Service 215(b) for submission to the reimbursing company 105.

When a user Resubmits/Edits Reimbursements 216 the process is similar to Creating a New Reimbursement 209 but certain fields may be inaccessible if the reimbursement has already been submitted. If a reimbursement has been submitted, the system/application may limit the nature of the modifications that can occur. Trip details as depicted in section 210(b) along with provider information [218] can only be changed in a nature that shall equate to distances defined by the system/application limitations. If the reimbursement has been saved and not submitted, all fields are available for editing in 216, 217, and 218, but may be subject to system or methodology changes. The system will Compute Value, Interest, and Service Fees 213(b). If the user decides to submit or resubmit an edited reimbursement an Invoice Transaction 214(b) may occur, data may be saved 202(c), and the reimbursement may be sent via the Record Processing Service 215(b).

At any time, an authenticated user will be able to Create/Edit Insurance Information 204 that will be able to be accessed from within Creating or Editing Reimbursements 209, 216.

At any time, an authenticated user will be able to Create/Edit Provider Information 205 that will be able to be accessed from within Creating or Editing Reimbursements 209, 216.

At any time, an authenticated user will be able to Edit Personal Information 206 that may be utilized in Computing Reimbursement Value 213(a), 213(b) and system wide contact and authentication information among other uses.

At any time, an authenticated user will be able to access a Reimbursement Summary List 207 that could act as a portal/query for one or more of the user's prior reimbursements.

At any time, an authenticated user will be able to access Payment History 208 where they can view/print records for one or multiple payment transactions 214(a), 214(b). Additional functionality may be added to allow queries and other features that will be useful to view and track payment history.

All of the interactions, 204-208 interfaces with the Data Storage Module 202(b) in-order to load and save user data.

Although the organization described in FIG. 2 above embodies the present invention for users, those of ordinary skill in the industry may recognize that the functionality can be achieved through different organizational hierarchies than those described above.

FIG. 3 shows one of many possible workflow options for a Transportation User 101. A Transportation User 101 may be an independent driver, transportation company, any person or entity offering medical transportation services to a client/customer with an expectation of reimbursement. A Transportation User 101 may interact with any User within the application/system and can have functionality inserted into any embodiment of this invention and thus gain additional capability within the system in order to better facilitate their role within the reimbursement process. FIG. 3 section 301 will present a user interface capable of facilitating Transportation User 101 account creation on any supported device. There may be additional data collected during a Transportation User 101 Account Creation 301, such as Department of Transportation credentials or other details that can be used to certify the validity of a Transportation User. In the event that a Transportation Users 101 Account Creation 301 is successful, it will initiate the new account details to be stored on the Data Storage Module 302a. During this process, Record Processing Service 315(a) may also be used to verify the newly created account. If used, the process of account verification may change from time to time depending on the account types and changing requirements for successful verification. After a Transportation User 101 has successfully created an account they will be able to proceed with secure authentication. Once a Transportation User 101 is Authenticated 303, in this embodiment they will be able to Create a New Reimbursement 311, Resubmit/Edit Unpaid Reimbursements 319, Create/Edit Insurance Information 304, Create/Edit Provider Information 305, Edit Personal Information 306, access a Reimbursement Summary List 307, and access Payment History 308, in addition to added functionality put into practice to assist Users to process reimbursement payment requests. The Transportation User 101 gains the additional functionality of a Trip Scheduling Module 309, and a Driver Assignment Module 310.

When a Transportation User 101 Creates a New Reimbursement 311, they will be able to have the option to pull reimbursement data from an established User that they have transported previously 312(a). The process of pulling data from a transported user 312(a) may require additional levels of verification. In the event that a Transportation User [101] cannot pull existing data, or prefer manual entry, they may have the option to enter the reimbursement time period 312(b), then Add/Use Existing Claim & Insurance Information 313. The Transportation User may be able to utilize data they have previously entered in this section at step 313 that may be loaded from the Data Storage Module 302(c). The Transportation User 101 gains additional capability when they Enter Trips for Reimbursement with Expanded Functionality 316. A Transportation User 101 will be able to set both the start and end addresses for reimbursement trips during step 316. During the process of adding trips 316, a Transportation User 101 will also be able to Add/Use Existing Provider Information 317. Previously entered data may be loaded from the Data Storage Module 302(c) during steps 311-317 to reduce the amount of manual data entry needed among operations. As trips are entered into the system/application, it will Compute Value, Interest, and Service Fees 318(a) associated with the reimbursement. The computations in 318(a) & 318(b) may use a plurality of data sources and methods for computing the value, interest, and service fees associated with the reimbursement.

Once a Transportation User 101 reimbursement has accumulated sufficient data, users may choose to save the reimbursement request for later submission via the Data Storage Module 302(c) or the Transportation User 101 may submit the data for reimbursement payment to the reimbursing company 105. If users choose to submit the reimbursement request, then an Invoice Transaction 314(a) will occur, which shall not exclude subscription options and processes to accommodate subscription based service. The reimbursement request may have data content stored in the Data Storage Module 302(c), and may be submitted to the Record Processing Service 315(b) for submission to the reimbursing company 105.

When a Transportation User 101 Resubmits/Edits Reimbursements 319 the process is similar to Creating a New Reimbursement 311, but certain fields may be inaccessible if the reimbursement has already been submitted. If a reimbursement has been submitted, the system/application may limit the nature of the modifications that can occur. The time period 312(b) may remain unchanged or may be allowed to change with or without restrictions. Trip details as depicted in section 320 along with provider information [321] can only be changed in a nature that equate to distances defined by the system/application limitations. The trip operations 320 may also contain expanded functionality for Transportation Users 101 when editing a reimbursement. If the reimbursement has been saved and not submitted, all fields are available for editing in 319, 320, and 321, but may be subject to system or methodology changes. The system will Compute Value, Interest, and Service Fees 318(b). If the User decides to submit or resubmit an edited reimbursement an Invoice Transaction 314(b) may occur, data may be saved 302(c), and the reimbursement request may be sent via the Record Processing Service 315(b).

An authenticated Transportation User 101 will be able to Create/Edit Insurance Information 304 that will be present when Creating a New Reimbursement 311 or Resubmitting/Editing Reimbursements 319.

An authenticated Transportation User 101 will be able to Create/Edit Provider Information 305 that will be present when Creating a New Reimbursement 311 or Resubmitting/Editing Reimbursements 319.

An authenticated Transportation User 101 will be able to Edit Personal Information 306 that may be utilized in Computing Reimbursement Value 318(a), 318(b), driver assignment 310, trip scheduling 309, and system wide contact and authentication information among other possible uses.

An authenticated Transportation User 101 will be able to access a Reimbursement Summary List 307 that could act as a portal/query for one or more of the user's prior reimbursements.

An authenticated Transportation User 101 will be able to access Payment History 308 where they can view/print records for one or multiple payment transactions 314(a), 314(b). Additional functionality may be added to allow queries and other features that will be useful to view and track payment history.

An authenticated Transportation User 101 may gain access to a Trip Scheduling Module 309 in which they may be able to plan and track reimbursable trips with other users of the system. An authenticated Transportation User 101 may gain access to a Driver Assignment Module 310. An embodiment of this module may allow the assignment of Transportation Users 101 to reimbursable trips. All of the interactions, 304-310 interface with the Data Storage Module 302(b) in-order to load and save data pertinent to the operation of those sections.

Due to the special nature of their role in the reimbursement process, Transportation Users 101 may also gain additional functionality not listed in FIG. 3 as requirements evolve.

FIG. 4 demonstrates an embodiment of a possible workflow that a Reimbursing Company [105] could experience while using the invention. FIG. 4 could also represent one of several workflows a processor at a Reimbursing Company could experience while using the application/system. A Reimbursing Company 105 may work directly or indirectly with the system. An indirect workflow may encompass the Reimbursing Company 105 receiving notifications and documents through the invention, and in turn working directly with a Transportation 101 or Service User 100 among other possible uses. A more interconnected workflow illustrated in FIG. 4 allows the Reimbursing Company 105 to access the system directly.

In this embodiment, the first step a Reimbursing Company 105 would take to access the system would be to undergo Account Creation for Authorized Users 401. Step 401 could present an interface on any compatible device for enrollment/account creation or it may require manual authorization from an Administrative User. Once an account or accounts are created, they will be stored in the Data Storage Module 402(a). The Record Processing Service 415(a) may also be used to assist with validating accounts. A Reimbursing Company 105 may have a master account to which sub accounts can be assigned, allowing individual or multiple processors at a Reimbursing Company 105 to create accounts using processes 401, 402(a), and 415(a). Once a valid account is obtained, the Reimbursing Company 105 may Authenticate 403 with the service. This embodiment will be provided with options to: Request Functionality/Customization 404, Manipulate and analyze data in the Data Module 405, Edit Company Information 406, Assign claims 407, Edit Account Information 408, and Process Reimbursements 410. Increased options may be added at a later time to enhance system/application usefulness, accessibility, and functionality.

A Reimbursing Company 105 may be able to Request Functionality/Customization 404 through the system/application once authenticated. One of many possible examples of this functionality could be a request to make data accessible to a Reimbursing Company's 105 internal systems.

A Reimbursing Company 105 may have access to a Data Module 405 that provides access to Data Analysis, Reporting, Historical data, Data exporting 409, and other possible options related to data processing. One of many possible examples is for module 405 to allow a Reimbursing Company to view reports related to reimbursements paid within a particular month and year.

A Reimbursing Company 105 may have access to Edit Company Information 406. In the embodiment, this option would allow a company to specify contact or other information. This information may propagate out into Service User 100 and Transportation User 101 accounts to reduce data input requirements and increase data accuracy for all parties.

A Reimbursing Company 105 may access a function to Assign claims 407 as defined by system/applications rules and limitations. This functionality would be important for workflow management for processors within a Reimbursing Company 105. A processor with Assigned claims 407 may possibly have the option to view only reimbursements associated with claims assigned to them among many other helpful workflow enhancements such as notifications only for reimbursements assigned to them or may access reimbursement request and other data based on authority granted by System/application administrators or anyone with authority to grant User/Processor data access.

A Reimbursing Company 105 may be able to Edit Account Information 408 that may be utilized in system wide contact and authentication information among other possible uses.

All items 404-409 interface with Data Storage Module 402(b) to load and store data critical to the functionality of 404-409.

Processing Reimbursements 410 will be at the core of the Reimbursing Company's 105 functionality within this embodiment. When starting to Process Reimbursements 410, a Reimbursing Company 105 may find it helpful to first Filter Records 411. In this embodiment, Filter Records Begin Processing Reimbursement [411], which may allow searching by particular claim identifiers or other criteria as defined within the application/system or by System Administrators. After reimbursement processing has begun 411, a key task is Verifying Trips 412. Verification can be performed manually with the assistance of information provided by Service Users 100 and Transportation Users 101 or by initiating a function within their reimbursement requests, or a Reimbursing Company 105 can utilize system tools to help with verification. In order to assist with verification, a Reimbursing Company 105 could Request Additional Information 413 from the User that submitted a reimbursement request. Requesting Additional Information 413 may also utilize the Record Processing Service 415(b) to send notifications to the User that additional information has been requested and in turn notify the Reimbursing Company 105 when the user provides the desired information. Traditionally, the process of trip verification can be quite tedious involving manual contact of service providers for each trip. The Optional Auto Verification Process 414 would provide a sufficient enhancement and time savings for Trip Verification 412 by communicating information and initiating verification requests with service providers in an automated application/system on behalf of the Reimbursing Company 105, Service Users 100, and Transportation Users 101. The Optional Auto Verification Process 414 may utilize the Record Processing Service 415(c) for contacting service providers and providing notification back to the Reimbursing Company 105, Service Users 100, or Transportation Users 101 once a trip has been verified or denied. Throughout the process of Verifying Trips 412, a Reimbursing Company 105 will be marking trips as verified/approved, denied/pending or awaiting additional information.

In one of many possible embodiments, a Reimbursing Company 105 has the option to enter messages for Users on each trip they verify, deny, or pend for additional review during 412. As trips are verified or denied, the system will Compute Value of reimbursement payment, Interest, and related Service Fees 416, not to exclude subscription offerings. Once trip verification 412 and computing values 416 are complete, then the Reimbursing Company 105 will have the option to Accept, Deny, Modify, the Reimbursement 417 or select an option to pend reimbursement payment for additional review. When Accepting, Denying or modifying a Reimbursement request 417, a Reimbursing Company 105 can enter messages describing an explanation for reimbursement decisions. Any messaging may be communicated to Users that are requesting reimbursement. As presented in the embodiment, this could be Service Users 100 or Transportation Users 101. After a reimbursement has been accepted or denied 417, a Transaction 418 may occur or a record may be saved to be used for other transactions. All data will be stored in the Data Storage Module 402(c) that is related to Processing Reimbursements 410, reimbursement status which includes acceptance, denial, or modifications 417, and transaction section 418. Data may also be submitted to the Record Processing Service 415(d) to help facilitate notifications and communication between parties.

Due to the special nature of their role in the reimbursement process, Reimbursing Companies 105 may also gain additional functionality not listed in FIG. 4 as requirements evolve.

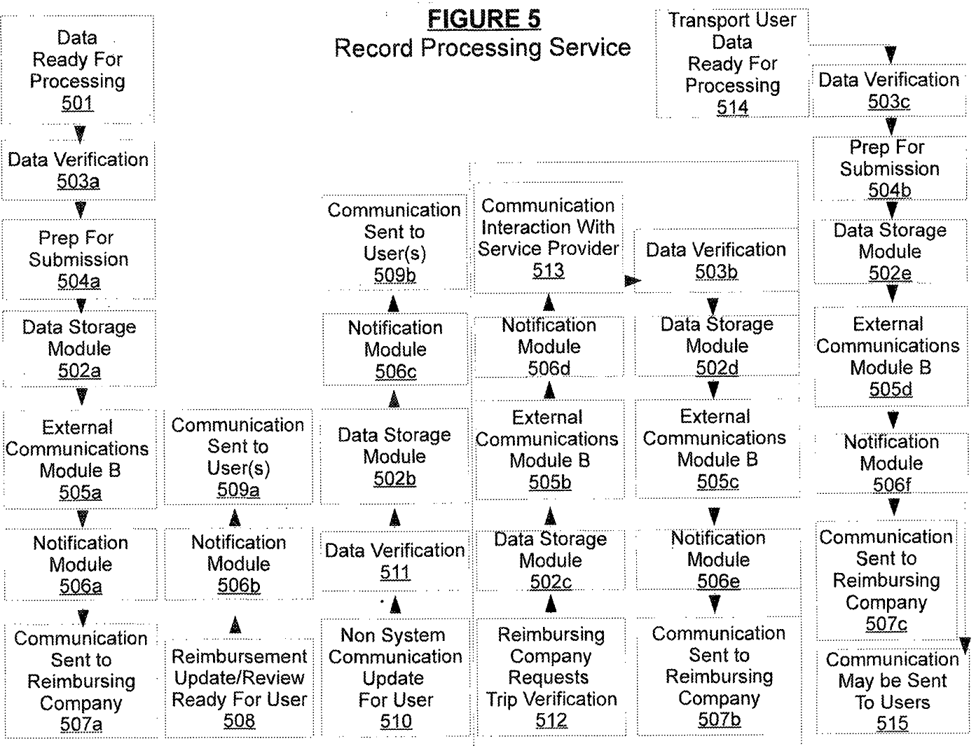

FIG. 5 demonstrates an embodiment of the Record Processing Service 103 featuring communication flows that could originate from operations occurring in FIG. 2, FIG. 3, and FIG. 4. Section 501 initiates a process flow that could originate from FIG. 2 section 215(b). Section 501 would receive Data Ready for Processing designated for submission to the Reimbursing Company 105. Data Verification 503(a) ensures that data received is verified and presented in the correct format. Any additional preparations that will be completed to prepare a reimbursement submission to a Reimbursing Company 105, is achieved through 504a “In Prep for Submission”. Depending on the type of communication used, 504(a) could be generating files stored in a secure manner among other possible operations. After Prep for Submission 504(a), any data that needs to be updated for the transaction or file metadata will be stored in the Data Storage Module 502(a). Section 505(a) External Communications Module B may be used to interface with standard computing methods to communicate across networks to external services to facilitate sending communications via the Notification Module 506(a). Notification Module 506(a) in this embodiment is a process before a file, physical document, or other Communication is “Sent to Reimbursing Company” as depicted in 507(a).

Section 508, Reimbursement Update/Review Ready for User demonstrates an embodiment of the Record Processing Service 103 featuring possible communication routes that could originate from a Reimbursing Company 105 in FIG. 4 steps 415(b), 415(c), or 415(d). From there, the communication flows to the Notification Module 506(b) which will facilitate the Communications Sent to User(s) 509(a). This process may use standard computing methods to communicate across networks or it may interact with other parties to get the communications to the Users.

Non-System Communication Update for Users 510 is intended in this embodiment to represent a communication that the system may have received from an external source. Examples may include but are not limited to the following: automated phone calls, email messages, text messages, faxes, and any other form of communication that the system can implement into its functionality. The received data must go through Data Verification 511 to verify and convert any needed information into a format that is compatible with the system/application. Verified data is then routed to the Data Storage Module 502(b) to be stored for later viewing, or other needs. The Non-System Communication Update for Users 510 is then routed to the Notification Module 506(c) which will facilitate the Communications Sent to User(s) 509(b). This process may use standard computing methods to communicate across networks, or it may interact with other parties to send the communications to users at 509(b).

In Section 512 “Requests Trip Verification”, when initiated by a Reimbursing Company [105] it is meant to represent a possible communication flow or verification request as seen originating in FIG. 4, section 415c. This communication could originate when a Reimbursing Company 105 decides to utilize the system to verify a reimbursable trip for payment and/or review. The Data Storage Module 502(c) stores the request and passes it on to External Communications Module B 505(b). As in the other steps, External Communications Module B 505(b) may use standard computing methods to communicate across networks or utilize an external service.

Notification Module 506(d) handles the delivery of the Communication Interaction with a Service Provider 513. A Service Provider 104 as shown in step 513 can also be seen in FIG. 1, 104. The “Communication Interaction with Service Provider” 513 would invoke a response from/to the system that is routed to Data Verification 503(b). After the response data from the Service Provider 104 has been verified as depicted in 503(b), it will be stored in the Data Storage Module 502(d) before being forwarded to External Communications Module B 505(c). External Communications Module B 505(c) will interact with Notification Module 506(e) which may use standard computing methods to communicate across networks or interface with another party to deliver the communication to the Reimbursing Company 105 in step Communication Sent to Reimbursing Company 507(b). The system may automatically update the trip verification in FIG. 4 based on the results sent in 503(b)-507(b). Notification methods may also change in section 507(b) based on information set by a Reimbursing Company 105 in FIG. 4.

In the embodiment, when Transport User Data is Ready for Processing 514 it follows a similar process as Data Ready for Processing 501. There are some key differences. Transport User Data Ready for Processing 514 can be seen in this embodiment starting in FIG. 3, section 315(b). This is when a reimbursement is ready to submit to a Reimbursing Company 105. After step 514, the process proceeds to Data Verification 503(c) to ensure that all the information is verified before Prep for Submission 504(b). During Prep for Submission 504(b), files may be generated from data within the system related to this transaction.

Data Storage Module 502(e) will facilitate storage of any pertinent data related to the communication before sending it to External Communications Module B 505(d). External Communications Module B 505(d) will work with Notification Module 506(f) using standard computing practices to communicate across networks or interface with other parties to facilitate the Communication Sent to the Reimbursing Company 507(c), 105 and the Communication may also be Sent to Users 515, 100. In this embodiment, step 515 may allow a Service User 100 that was transported by a Transportation User 101 know that a Transportation User 101 submitted a reimbursement for transportation. In practice, steps 507(c) and 515 may occur differently and the description is not intended to limit the possibilities of messaging described.

Although the charts presented in FIG. 1, FIG. 2, FIG. 3, FIG. 4, and FIG. 5 represent the preferred embodiment of the invention at time of filing; workflows may change as requirements evolve throughout the life span of the invention.

1. The invention claimed is a computer-implemented method executed by a system/platform that interacts with policy holders, insureds, claimants, transportation companies, service providers, insurance companies, and representatives of those mentioned to collect and manage medical service appointments and trip data for the purpose of requesting and/or processing payments related to medical mileage and related transportation reimbursements comprising of:
one or more internet accessible servers including a processor, memory, non-volatile storage, and input/output devices capable of execution of the necessary computer code for system functionality and to facilitate communications over networks;
transmission of computer code and data to personal computing devices including a processor, memory, storage, and input/output devices capable of executing the necessary computer code to allow bilateral communication between said internet accessible server(s) and personal computing device(s) as well as rendering of a user interface when policy holders, insureds, claimants, transportation companies, service providers, insurance companies, and representatives of those mentioned interact with the said internet accessible server(s) using a personal computing device;
allowing any user to access an interactive self-service-based computer program/application platform to execute requests for medical mileage and related transportation reimbursements as opposed to only allowing access to specific users.

2. The computer-implemented method of claim 1 wherein any user may create accounts within a system/platform or access the platform without an account to request reimbursement payments related to medical mileage reimbursements.

3. The computer-implemented method of claim 1 wherein medical service trip mileage detail is compiled, organized into forms/records, and assigned a monetary value.

4. The computer-implemented method of claim 1 wherein any system user can transmit requests for medical mileage reimbursements to an entity for payment processing.

5. The computer-implemented method of claim 1 wherein payment processing for medical mileage reimbursement requests are monitored for contractual or regulatory compliance and full payment.

6. The computer-implemented method of claim 1 wherein medical provider information can be stored for easy future recall to populate benefit request forms related to medical mileage reimbursements.

7. The computer-implemented method of claim 1 wherein any user may manage all current and/or historic medical mileage reimbursement data for the perpetual or limited life of the user.

8. The computer-implemented method of claim 1 wherein users can manage requests for medical mileage and related transportation reimbursements for various insurance companies and policies simultaneously.

9. The computer-implemented method of claim 1 wherein multiple parties can interact within a system/platform that allows data transmission through networks to share appointment and trip information, validate reimbursable medical appointments/trips, and assist each other with requests for medical mileage reimbursements.

10. The computer-implemented method of claim 1 wherein computer code executing on one or more internet accessible servers will process, store, and relay medical mileage reimbursement related communications between policy holders, insureds, claimants, transportation companies, service providers, insurance companies, and representatives of those mentioned.

11. The invention claimed is a computer-implemented process that makes use of a system/platform wherein policy holders, insured's, claimants, transportation companies, service providers, insurance companies including employees or personal representatives of any person or entity can carry out all the necessary functions to request or process reimbursement payments for medical mileage and related transportation expenses, and manage the history of all related business comprising of:
one or more internet accessible servers including a processor, memory, non-volatile storage, and input/output devices capable of execution of the necessary computer code for system functionality and to facilitate communications over networks;
transmission of computer code and data to personal computing devices including a processor, memory, storage, and input/output devices capable of executing the necessary computer code to allow bilateral communication between said internet accessible server(s) and personal computing device(s) as well as rendering of a user interface when policy holders, insureds, claimants, transportation companies, service providers, insurance companies, and representatives of those mentioned interact with the said internet accessible server(s) using a personal computing device;
allowing any user to access an interactive self-service-based computer program/application platform to execute requests for medical mileage and related transportation reimbursements as opposed to only allowing access to specific users.

12. The computer-implemented process of claim 11 wherein computer code executing on one or more internet accessible servers will process, store, and relay medical mileage reimbursement related communications between policy holders, insureds, claimants, transportation companies, service providers, insurance companies, and representatives of those mentioned.

13. The invention claimed is a computer-implemented process that makes use of a system/platform to allow transportation companies transporting policy holders, insureds, and claimants to appointments for medical services or pharmacies to perform all the necessary functions to request reimbursement for expenses within an interactive multiple user system comprising of:
one or more internet accessible servers including a processor, memory, non-volatile storage, and input/output devices capable of execution of the necessary computer code for system functionality and to facilitate communications over networks;
transmission of computer code and data to personal computing devices including a processor, memory, storage, and input/output devices capable of executing the necessary computer code to allow bilateral communication between said internet accessible server(s) and personal computing device(s) as well as rendering of a user interface when policy holders, insureds, claimants, transportation companies, service providers, insurance companies, and representatives of those mentioned interact with the said internet accessible server(s) using a personal computing device;

14. The computer-implemented process of claim 13 wherein authentication of the user as a transportation user occurs.

15. The computer-implemented process of claim 13 wherein reimbursement data from the transported user's records can be used to populate data fields for records/documentation.

16. The computer-implemented process of claim 13 wherein Users can add or use existing claim and insurance information to populate data fields for records/documentation.

17. The computer-implemented process of claim 13 wherein authenticated users can input or upload medical mileage reimbursement data for trips.

18. The computer-implemented process of claim 13 wherein a transportation user may have access to a driver assignment module that allows them to assign transportation requests to other transportation users within the system.

19. The computer-implemented process of claim 13 wherein a transportation user may have access to a trip scheduling module that can be used to setup future date and time engagements for the transportation of a user to an appointment eligible for medical mileage reimbursement.

20. The computer-implemented process of claim 13 wherein computer code executing on one or more internet accessible servers will process, store, and relay medical mileage reimbursement related communications between policy holders, insureds, claimants, transportation companies, service providers, insurance companies, and representatives of those mentioned.
